(19) United States
(12) Patent Application Publication
(10) Pub. No.: US 2013/0098902 A1
(43) Pub. Date: Apr. 25, 2013

(54) WOK SUPPORT FOR AN INDUCTION HOB

(71) Applicants: Harald Hoffmann, Rothenburg o.d. Tauber (DE); Armin Pojda, Rothenburg o.d. Tauber (DE)

(72) Inventors: Harald Hoffmann, Rothenburg o.d. Tauber (DE); Armin Pojda, Rothenburg o.d. Tauber (DE)

(73) Assignee: ELECTROLUX HOME PRODUCTS CORPORATION N.V., Brussels (BE)

(21) Appl. No.: 13/805,725

(22) PCT Filed: Jul. 13, 2011
(86) PCT No.: PCT/EP2011/003492

§ 371 Date: Dec. 20, 2012

(30) Foreign Application Priority Data
Jul. 17, 2010 (EP) 10007430.1

(51) Int. Cl. H05B 6/36

(52) U.S. Cl. CPC H05B 6/36
USPC 219/622

(57) ABSTRACT

The present invention relates to a wok support (10) for an induction hob (22), wherein said wok support (10) is provided for receiving a wok pan on its upper side and said wok support (10) is arrangable upon the induction hob (22). The wok support (10) includes at least one first coil (18) arranged in a lower part of said wok support (10) and at least one second coil (20) arranged in an upper part of said wok support (10). An upper side of the at least one second coil (20) is at least partially concave. The at least one first coil (18) is electrically connected to the at least one second coil (20). Further, the present invention relates to an induction hob with at least one induction coil, wherein said induction hob comprises and/or corresponds with at least one wok support (10).

The present invention relates to a wok support for an induction hob according to the preamble of claim 1. Further, the present invention relates to an induction hob with at least one induction coil.

The wok pan has the form of a segment of a spherical shell. Known wok supports for induction hobs use a construction for holding the wok pan in its designated position. The form of the wok pan and the known wok supports cause a disadvantageous heat distribution in the wok pan and a low power performance. Further, electromagnetic compliances may occur, if the induction coil is not covered completely.

DE 41 42 683 A1 discloses a wok pan with support means at its lower side. The support means allow a stable arrangement of the wok pan on an induction cooking hob. The support means are permanently fastened at the wok pan.

DE 296 03 625 U1 describes a holding device for wok pans. The holding device is arrangable on the induction hob. Thereby the holding device covers the complete induction hob. The holding device comprises a circular hole for receiving the wok pan. The wok pan is held at a marginal distance above the surface of the induction hob.

DE 196 00 322 C1 discloses a holding device for wok pans, which holding device is arrangable on the induction hob. The holding device comprises a circular hole for receiving the wok pan and support columns.

DE 299 05 024 U1 describes a flexible support equipment for a wok pan. The support equipment holds the wok pan within the environment of the induction coil.

It is an object of the present invention to provide an improved wok support for an induction hob, wherein said wok support allows an optimized heat distribution in the wok pan and a high power performance.

The object of the present invention is achieved by the wok support according to claim 1.

According to the present invention the wok support includes at least one first coil arranged in a lower part of said wok support and at least one second coil arranged in an upper part of said wok support, wherein an upper side of the at least one second coil is at least partially concave, and wherein the at least one first coil is electrically connected to the at least one second coil.

The main idea of the present invention are the electrically connected coils within the wok support, wherein the lower coil is adapted to the upper side of the induction hob and the upper coil is adapted to the contour of the wok pan. Thus, also the geometric form of the magnetic field is adapted to the contour of the wok pan. This allows an optimized heat distribution in the wok pan and a high power performance. The wok support can be used with a standard induction hob. The wok support requires no external power supply. There is only a low risk of exceeding the electric and/or magnetic field strength.

According to a preferred embodiment of the present invention the at least one first coil has a flat form and extends horizontally. Thereby the first coil is adapted to the structure of the induction hob.

Preferably, the wok support includes a housing with a top wall and a bottom wall. The housing allows a compact structure of the wok support.

Further, the top wall of the housing may comprise at least partially a concave upper surface. The top wall is adapted to the wok pan as well as to the second coil.

Additionally, the concave upper surface of the top wall may be adapted to the contour of the wok pan.

In a similar way, the bottom wall of the housing may comprise at least partially a flat lower surface. Thus, the bottom wall is adapted to the induction hob. Further, the wok support comprises at least one thermal cutout. This is a protection against overheating.

For example, the thermal cutout comprises a thermo mechanical element.

Alternatively or additionally, the thermal cutout comprises a thermo electric and/or thermo electronic element.

Preferably, the wok support comprises at least one heat transmission element extending from the top wall to the bottom wall, so that temperature of the wok pan is transferred to a sensor of the induction hob. The sensor of the induction hob can be used by low complexity.

Further, the wok support may comprise and/or correspond with at least one wok pan, wherein the contour of said wok pan is adapted to the at least one concave second coil.

For example, at least one further second coil comprises an oval shape. In this case, the wok support provides an additional contour of a heating zone.

In a similar way, at least one further second coil may comprise a rectangular shape.

Additionally, at least one further second coil may comprise a flat form and is covered by a metal plate. Thus, the wok support is also capable for preparing teppan yaki.

Further, the present invention relates to an induction hob with at least one induction coil, which comprises and/or corresponds with at least one wok support as described above.

Novel and inventive features of the present invention are set forth in the appended claims.

The present invention will be described in further detail with reference to the accompanied drawing, in which

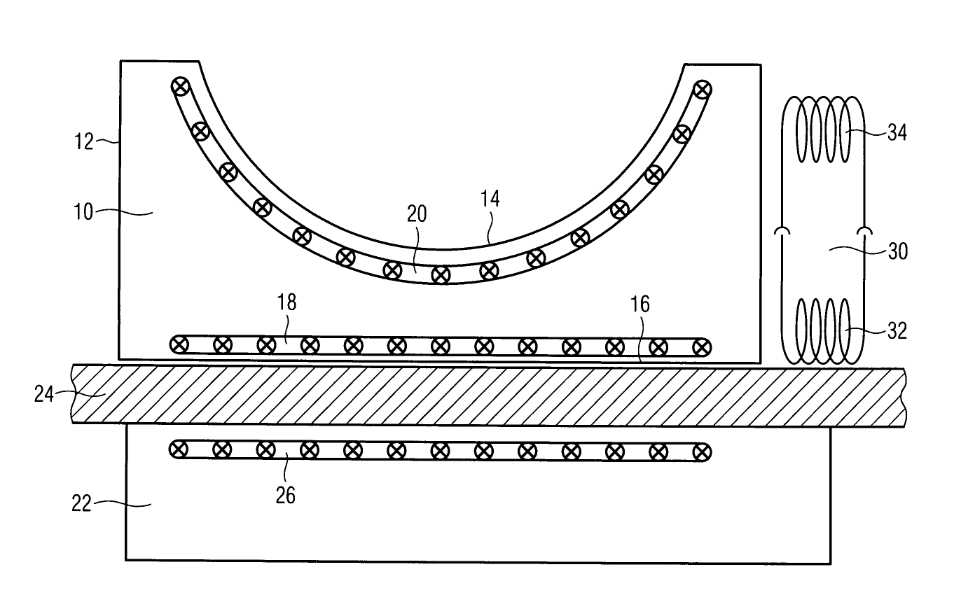

FIG. 1 illustrates a schematic sectional side view of a wok support according to a preferred embodiment of the present invention.

FIG. 1 illustrates a schematic sectional side view of a wok support 10 according to a preferred embodiment of the present invention. The wok support 10 is arranged on an induction hob 22.

The wok support 10 includes a housing 12. The housing 12 comprises a top wall 14 and a bottom wall 16. The top wall 14 of the housing 12 includes a concave sheet section in its central portion. The bottom wall 16 of the housing 12 is formed as a plane sheet.

The concave top wall 14 of the housing 12 is provided for receiving a wok pan. The wok pan has the form of a segment of a spherical shell. For example, the curvature of the concave top wall 14 is adapted to the curvature of the wok pan, so that the concave top wall 14 is complementary to at least the lower portion of the wok pan.

The wok support 10 includes a first coil 18 and a second coil 20. The first coil 18 is arranged above the bottom wall 16 of the housing 12. The second coil 20 is arranged below the top wall 14 of the housing 12. The first coil 18 has a flat form and is arranged parallel to the bottom wall 16 of the housing 12. The second coil 20 has a concave form and is adapted to the contour of the top wall 14 of the housing 12. The first coil 18 is electrically connected to the second coil 20, so that an electric circuit is closed.

Preferably, the first coil 18 and the second coil 20 are made of copper wires. Further, ferrite elements are provided for concentrating the magnetic field in the copper wires of the first coil 18.

The induction hob 22 includes a glass panel 24 and at least one induction coil 26. The induction coil 26 has a flat form and is arranged below the glass panel 24. The wok support 10 is arranged on the induction hob 22, so that the first coil 18 of said wok support 10 is located above the induction coil 26 of the induction hob 22.

FIG. 1 includes a circuit diagram 30 of the first coil 18 and the second coil 20. The circuit diagram 30 does not relate to any additional components, but represents the electric connections of the first coil 18 and the second coil 20. The circuit diagram 30 comprises a graphical symbol 32 of the first coil 18 and a graphical symbol 34 of the second coil 20.

The wok support 10 is arranged upon the induction hob 22, so that the first coil 18 of the wok support 10 is placed above the induction coil 26 of said induction hob 22. The induction coil 26 generates a magnetic field inducing an electric current in the first coil 18. Said electric current generates a magnetic field in the second coil 20. Said magnetic field heats up a wok pan arranged upon the top side 14 of the wok support 10.

In order to protect the system from overheating an internal sensor of the induction hob 22 can be used. In this case the wok support 10 comprises at least one heat transmitting element conducting the heat form the wok pan down to the cooking zone of the induction hob 20.

Alternatively, the electric connection between the first coil 18 and the second coil 20 can be interrupted by a thermal cutout or an electric or electronic control circuit.

The wok support 10 according to the present invention allows an improved heat distribution inside the wok pan in comparison with a mechanical wok support. The inventive wok support 10 can be used with an arbitrary standard induction hob. Said wok support 10 requires no external power supply. Further, the inventive wok support 10 allows a higher power performance than a mechanical wok support. The risk of exceeding the strength of the electromagnetic field is reduced by the inventive wok support 10.

The wok support 10 may include further second coils, which are not shown in FIG. 1. For example, the wok support 10 may comprise one or more second coils with an oval and/or rectangular shape. An additional second coil of the wok support 10 may be covered by a metal plate in order to prepare teppan yaki.

Although an illustrative embodiment of the present invention has been described herein with reference to the accompanying drawing, it is to be understood that the present invention is not limited to that precise embodiment, and that various other changes and modifications may be affected therein by one skilled in the art without departing from the scope or spirit of the invention. All such changes and modifications are intended to be included within the scope of the invention as defined by the appended claims.

### LIST OF REFERENCE NUMERALS

10 wok support
12 housing
14 top wall
16 bottom wall
18 first coil
20 second coil
22 induction hob
24 glass panel
26 induction coil
30 circuit diagram
32 graphical symbol of the first coil
34 graphical symbol of the second coil

1. A wok support (10) for an induction hob (22), wherein said wok support (10) is provided for receiving a wok pan on its upper side and said wok support (10) is arrangable upon the induction hob (22),
characterized in, that
the wok support (10) includes at least one first coil (18) arranged in a lower part of said wok support (10) and at least one second coil (20) arranged in an upper part of said wok support (10), wherein an upper side of at least one second coil (20) is at least partially concave, and wherein the at least one first coil (18) is electrically connected to the at least one second coil (20).

2. The wok support according to claim 1, characterized in, that the at least one first coil (18) has a flat form and extends horizontally.

3. The wok support according to claim 1, characterized in, that the wok support (10) includes a housing (12) with a top wall (14) and a bottom wall (16).

4. The wok support according to claim 1, characterized in, that the top wall (14) of the housing (12) comprises at least partially a concave upper surface.

5. The wok support according to claim 1, characterized in, that the concave upper surface of the top wall (14) is adapted to the contour of the wok pan.

6. The wok support according to claim 1, characterized in, that the bottom side (16) of the housing (12) comprises at least partially a flat lower surface.

7. The wok support according to claim 1, characterized in, that the wok support (10) comprises at least one thermal cutout.

8. The wok support according to claim 7, characterized in, that the thermal cutout comprises a thermo mechanical element.

9. The wok support according to claim 7, characterized in, that the thermal cutout comprises a thermo electric and/or thermo electronic element.

10. The wok support according to claim 1, characterized in, that the wok support (10) comprises at least one heat transmission element extending from the top wall (14) to the bottom wall (16), so that the temperature of the wok pan is transferred to a sensor of the induction hob (22).

11. The wok support according to claim 1, characterized in, that the wok support (10) comprises and/or corresponds with at least one wok pan, wherein the contour of said wok pan is adapted to the at least one concave second coil (20).

12. The wok support according to claim 1, characterized in, that at least one further second coil comprises an oval shape,

13. The wok support according to claim 1, characterized in, that at least one further second coil comprises a rectangular shape.

14. The wok support according to claim 1, characterized in, that at least one further second coil comprises a flat form and is covered by a metal plate.

15. An induction hob with at least one induction coil, characterized in, that the induction hob comprises and/or corresponds with at least one wok support (10) according to claim 1.
